(19) United States
(12) Patent Application Publication
(10) Pub. No.: US 2019/0340220 A1
(43) Pub. Date: Nov. 7, 2019

(54) METHOD AND SYSTEM FOR DETERMINING IMPORTANCE OF PHARMACEUTICAL PRODUCTS AND COMBINATIONS THEREOF WITHIN A DOCUMENT

(71) Applicants: Bruno Larvol, San Francisco, CA (US); Christian Hayden, San Francisco, CA (US)

(72) Inventors: Bruno Larvol, San Francisco, CA (US); Christian Hayden, San Francisco, CA (US)

(21) Appl. No.: 15/971,189

(22) Filed: May 4, 2018

(51) Int. Cl. G06F 17/22; G06F 17/27; G06K 9/00

(52) U.S. Cl. CPC G06F 17/22; G06K 9/00456; G06F 17/278

(57) ABSTRACT

A system to determine importance of pharmaceutical products and combinations of pharmaceutical products named in a document is provided. The system comprises a processor, a memory, and an application stored in the memory, that when executed on the processor identifies at least one entity named in a document. The system also accesses at least one database describing at least one of pharmaceutical products, combinations of pharmaceutical products, attributes of the products, and attributes of the combinations. The system also compares the at least one entity with each of the products, with each of the combinations, and with each of the attributes. The system also assigns, based at least on the comparisons, an importance rating to each pharmaceutical product and combination thereof named in the document.

### FIELD OF INVENTION

The present invention relates to determining the importance of pharmaceutical products or combinations of pharmaceutical products; more particularly, to determining the importance of pharmaceutical products within a document or text.

### BACKGROUND

Documents related to pharmaceutical products often mention many pharmaceutical products of varying levels of importance to the thesis of the document. Conventional methods of determining the importance of pharmaceutical products within a given text (an article, abstract, publication of clinical data, scholarly paper) include manually retrieving and reading the document to identify which pharmaceutical product or products the document most pertains to. This is a challenging process as there is a continuous tedious task of reading documents and categorizing them manually. The problem of reader bias can also affect manual review and categorization. While it may be possible to automatically identify all of the pharmaceutical products or combinations of pharmaceuticals in a given document, automated processes which determine the importance of the pharmaceutical products relative to others in a document do not exist.

Thus, there is a need to provide methods and systems to automatically determine the importance of pharmaceutical products in a document that references multiple pharmaceutical products so that it is easier for users to access information regarding the pharmaceutical products.

### SUMMARY

This summary is provided to introduce a selection of concepts, in a simplified manner, which is further described in the detailed description of the invention. This summary is neither intended to identify key or essential inventive concepts of the subject matter, nor to determine the scope of the invention.

One embodiment of the invention comprises a system which determines an importance of at least one of a pharmaceutical product or a combination of pharmaceutical products within a document. The system extracts a plurality of entities from the document. The system compares the plurality of entities extracted from the document against a database of pharmaceutical products or combinations of pharmaceutical products and certain attributes pertaining to the pharmaceutical products or combinations of pharmaceutical products. The system assigns an importance rating to each pharmaceutical product or combinations of pharmaceutical products extracted from the document using the attributes present in the database of pharmaceutical products or combinations of pharmaceutical products, the importance rating reflecting each pharmaceutical product's importance or combinations of pharmaceutical products' importance within the document.

In one embodiment of the invention, a computer implemented method comprises determining an importance of at least one of a pharmaceutical product or a combination of pharmaceutical products within a document. The method extracts a plurality of entities from the document. The method compares the plurality of entities extracted from the document against a database of pharmaceutical products or combinations of pharmaceutical products and certain attributes pertaining to the pharmaceutical products or combinations of pharmaceutical products. The method further assigns an importance rating to each pharmaceutical product or combinations of pharmaceutical products extracted from the document using the attributes present in the database of pharmaceutical products or combinations of pharmaceutical products, the importance rating reflecting each pharmaceutical product's or combinations of pharmaceutical products' importance within the document.

To further clarify advantages and features of the present invention, a more particular description of the invention will follow with reference to specific embodiments thereof, which are illustrated in the appended figures. It is to be appreciated that these figures depict only typical embodiments of the invention and are therefore not to be considered limiting in scope. The invention will be described and explained with additional specificity and detail with the appended figures.

### BRIEF DESCRIPTION OF DRAWINGS

The invention will be described and explained with additional specificity and detail with the accompanying figures in which:

FIG. 1 is a block diagram of a computing system for determining the importance of pharmaceutical products in a document.

FIG. 2 is a block diagram to illustrate the determining of the importance of the pharmaceutical products in a document.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present invention so as not to obscure the figures with details that will be readily apparent to those skilled in the art having the benefit of the description herein.

### DETAILED DESCRIPTION OF THE INVENTION

For the purpose of promoting an understanding of the principles of the invention, reference will now be made to the embodiment illustrated in the figures and specific language will be used to describe them. It will nevertheless be understood that no limitation of the scope of the invention is thereby intended. Such alterations and further modifications in the illustrated system, and such further applications of the principles of the invention as would normally occur to those skilled in the art are to be construed as being within the scope of the present invention.

It will be understood by those skilled in the art that the foregoing general description and the following detailed description are exemplary and explanatory of the invention and are not intended to be restrictive thereof.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this invention belongs. The system, methods, and examples provided herein are only illustrative and not intended to be limiting.

Embodiments of the present invention will be described below in detail with reference to the accompanying figures.

Systems and methods described herein provide for identification of proper names of pharmaceutical products, names of combinations of pharmaceutical products, and associated information appearing in scholarly documents and other publications and documents of interest. Databases containing information about pharmaceutical products and related material are then accessed. The pharmaceutical product names and associated information extracted from the documents is compared to the material found in the databases. Based on the comparisons made by at least one application provided herein, the system determines an importance of each pharmaceutical product and combination of pharmaceutical products named in the particular document or group of documents being analyzed. Material drawn from the databases is used to support conclusions about relative importance of the pharmaceutical products and combinations thereof appearing in documents of interest.

The proper names of pharmaceutical products, combinations thereof, and associated information extracted from a document of interest may be referred to herein as entities. In addition to names of pharmaceutical products and combinations thereof, entities used to assist in determining importance of a pharmaceutical product or combination of pharmaceutical products in a given document include names of authors of the given document as well as authors' affiliations including employer, academic institution, government agency, and/or non-governmental organization (NGO). Entities identified in the document(s) of interest for use in comparison with material drawn from databases further includes clinical trials, names of sponsors of clinical trials, companies, and institutions including universities and NGOs.

Material drawn from databases against which document entities are compared includes pharmaceutical products and combinations thereof. But such database material also includes attributes associated with the products and their combinations. Such attributes include owners and co-owners of pharmaceutical products, phase of clinical development, therapeutic area or relevant disease, regulatory status, patent status, and clinical trial status. Attributes also include names of sponsors of clinical trials, names of institutions and investigators involved in clinical trials, and identification numbers of clinical trials.

In a simple example, a first pharmaceutical product and a second pharmaceutical product may be mentioned in a scholarly publication about various treatments for a disease. The products may be mentioned once each and in the same area of the publication. The name of the sponsor of the first product is mentioned in the publication while the name of the sponsor of the second product was not mentioned. Upon searching a reliable and respected database, stored material is found about both products. In the example, the name of the sponsor of the first product is found in many records in the database while little material is found about the sponsor of the second product. In this simplified example, the first pharmaceutical product would be given higher importance than the second pharmaceutical product.

In a second and more nuanced example, a first pharmaceutical product may receive numerous mentions in a document and a second pharmaceutical product may be mentioned only once in the document. By itself, this information might lead an observer to conclude that the first product should be ranked with more importance, at least as regards the document of interest. Systems provided herein conduct database queries and comparisons provided herein. Entities (the first and second pharmaceutical products) are compared and otherwise analyzed with material drawn from the databases (names of various pharmaceutical products, combinations thereof, and their various attributes).

In this second example, the application may find that while the first pharmaceutical product may be mentioned frequently within the document and the second pharmaceutical product is mentioned only a single time, the second product is found to be in a more advanced stage of clinical trials and/or has received more favorable results or ratings in such trials. This information may result in the system assigning a higher importance to the second pharmaceutical product than the first pharmaceutical product.

In practice of the present disclosure, multiple factors may enter into comparisons performed by the systems and methods provided herein. Many entities may be extracted from a document of interest. Many pharmaceutical product names and associated attributes may be drawn from databases which could contain hundreds or thousands of records containing references to pharmaceutical products and associated attributes.

Importance ratings may be increased based on determinations by the application that a pharmaceutical product or combination thereof has a non-expired patent status. Importance ratings may be also increased based on determinations that a clinical trial referenced in the document is or was sponsored by an owner of the pharmaceutical or combination thereof.

The application described herein may execute on a server or servers. The application may comprise more than one application and may include various components, for example at least an importance analyzer, an extract engine, and a search engine.

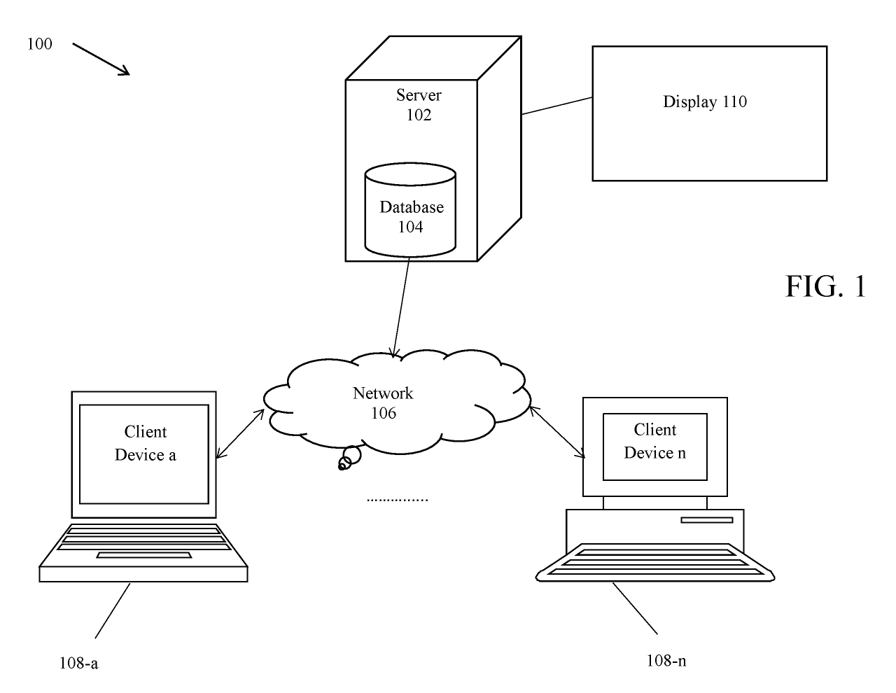

For some embodiments of the invention, FIG. 1 is a block diagram of a system 100 for determining the importance of a pharmaceutical product or a combination of pharmaceutical products within a document. According to an embodiment of the present disclosure, the system 100 provided herein comprises a communication system 100, which includes a computer system 110, a communication network 106, a server 102, a database 104, and a plurality of client devices 108a-n. The communication network 106 may be any wired or wireless network or LAN capable of conducting communication between multiple modules. A LAN is a network that usually spans a relatively short distance. Typically, a LAN is confined to a single building or group of buildings. Each individual computer system or device connected to the LAN preferably has its own Central Processing Unit, or processor, with which it executes programs, and each computer system is also able to access data and devices anywhere on the LAN. The LAN thus allows many users to share printers or other devices as well as data stored on one or more file servers. The LAN may be characterized by any of a variety of network topologies (i.e., the geometric arrangement of devices on the network), protocols (i.e., the rules and encoding specifications for sending data, and whether the network uses a peer-to-peer or client/server architecture), and media (e.g., twisted-pair wire, coaxial cables, fiber optic cables, radio waves).

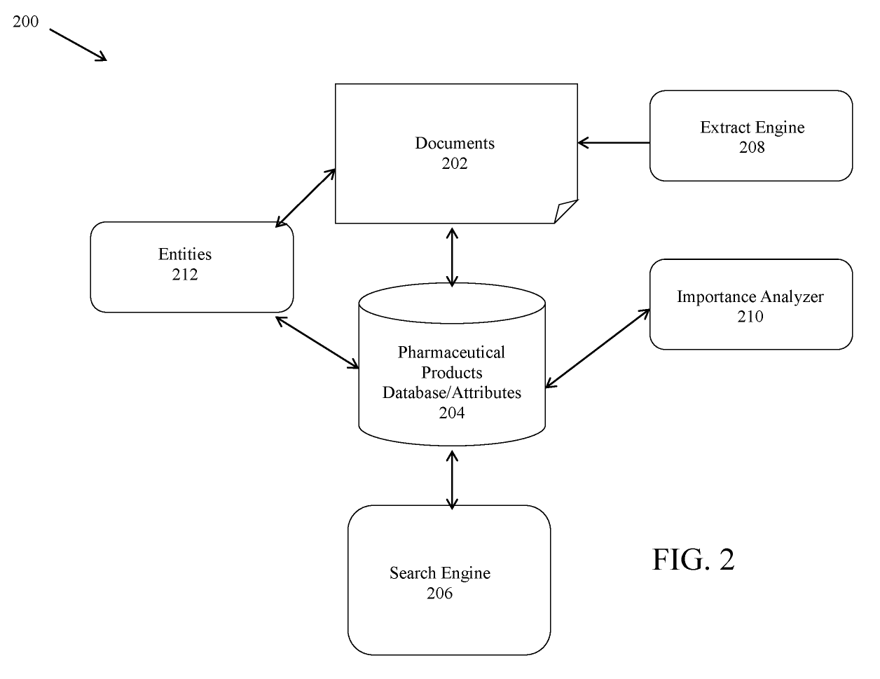

FIG. 2 is a block diagram 200 to determine the importance of a pharmaceutical product or a combination of pharmaceutical products within the document. In accordance with the present invention, the system 200 includes a plurality of entities which may be extracted from the documents 202. The plurality of entities extracted from the documents may be compared against a database of pharmaceutical products 204 or combinations of pharmaceutical products and certain attributes pertaining to the pharmaceutical products or combinations of pharmaceutical products. An importance rating may be calculated by an importance analyzer 210 which may be assigned to each pharmaceutical product or combinations of pharmaceutical products extracted from the documents 202 using the attributes present in the database of pharmaceutical products or combinations of pharmaceutical products, the importance rating reflecting the each pharmaceutical product's or combinations of pharmaceutical products' importance within the documents.

Process flows are provided for determining the importance of multiple pharmaceutical products or a combination of pharmaceutical products within a document. Processes include extracting a plurality of entities from the document. The plurality of entities extracted from the document may be compared against a database of pharmaceutical products or combinations of pharmaceutical products and certain attributes pertaining to the pharmaceutical products or combinations of pharmaceutical products. An importance rating may be assigned to each pharmaceutical product or combinations of pharmaceutical products extracted from the document using the attributes present in the database of pharmaceutical products or combinations of pharmaceutical products, the importance rating reflecting each pharmaceutical product's or combinations of pharmaceutical products' importance within the document.

The plurality of entities extracted from the document may consist of authors, author affiliations, pharmaceutical products or combinations of pharmaceutical products, clinical trials, clinical trials sponsors, companies, institutions, or the like. The attributes in the database may consist of owners and co-owners of the pharmaceutical products or combinations of pharmaceutical products, phase of clinical development of the pharmaceutical products or combinations of pharmaceutical products, therapeutic area or relevant disease of the pharmaceutical products or combinations of pharmaceutical products, regulatory status of the pharmaceutical products or combinations of pharmaceutical products, patent status of the pharmaceutical products or combinations of pharmaceutical products, clinical trials associated with the pharmaceutical products or combinations of pharmaceutical products, sponsors of the clinical trials, institutions or investigators involved in the clinical trials, identification numbers of the clinical trials or the like. The attributes may assist in determining the importance rating by increasing the importance rating if the pharmaceutical product's or combinations of pharmaceutical products' patent status is not expired, or if the clinical trial referenced in the document is sponsored by the company that owns the pharmaceutical products or combinations of pharmaceutical products. The importance rating may be increased or decreased based on the placement of the pharmaceutical product in the document. For example, if the product is featured in the title of the document, the importance rating may be increased.

The importance ratings assigned to the products within the document may be used to order the products by importance or to sort the products into categories such as primary or secondary or the like.

In accordance with the present invention, the system scans the title of the document and notes any pharmaceutical products found in the title field. Any pharmaceutical products or combinations of pharmaceutical products found in the title of the document may have their importance ratings increased. Any pharmaceutical products found in fields other than the title may have their importance rating decreased.

The system may suggest a greater importance of non-generic drugs or combinations of non-generic drugs found in a given document. The system may also suggest a lesser importance of generic drugs and combinations thereof.

While specific language has been used to describe the invention, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

1. A system to determine importance of pharmaceutical products and combinations of pharmaceutical products named in a document, comprising:
a processor;
a memory; and
an application stored in the memory, that when executed on the processor:
identifies at least one entity named in a document,
accesses at least one database describing at least one of pharmaceutical products, combinations of pharmaceutical products, attributes of the products, and attributes of the combinations,
compares the at least one entity with each of the products, with each of the combinations, and with each of the attributes, and
assigns, based at least on the comparisons, an importance rating to each pharmaceutical product and combination thereof named in the document.

2. The system of claim 1, wherein entities comprise authors, author affiliations, pharmaceutical products, combinations of pharmaceutical products, clinical trials, clinical trials sponsors, companies, and institutions.

3. The system of claim 1, wherein attributes comprise owners and co-owners of pharmaceutical products and combinations of pharmaceutical products, phase of clinical development of pharmaceutical products and combinations of pharmaceutical products, therapeutic area and relevant disease of pharmaceutical products or combinations of pharmaceutical products, regulatory status of pharmaceutical products or combinations of pharmaceutical products, patent status of pharmaceutical products or combinations of pharmaceutical products, clinical trials associated with pharmaceutical products or combinations of pharmaceutical products, sponsors of the clinical trials, institutions and investigators involved in clinical trials, and identification numbers of the clinical trials.

4. The system of claim 1, wherein importance ratings are increased based on at least one of determination by the application that one of a pharmaceutical product and a combination has a non-expired patent status and a determination that a clinical trial referenced in the document is or was sponsored by an owner of the pharmaceutical or combination.

5. The system of claim 1, wherein an importance rating is one of increased and decreased based on a placement of a pharmaceutical product in a document.

6. The system of claim 1, wherein an importance rating assigned to one of a pharmaceutical product and combination thereof within a document is used to at least one of order the products and combinations thereof by importance and to sort the products and combinations thereof into categories comprising at least one of primary and secondary.

7. A computer-implemented method for determining importance of pharmaceutical products and combinations of pharmaceutical products named in at least one document, comprising:
a computer identifying at least one entity named in at least one document;
the computer accessing at least one database describing at least one of pharmaceutical products, combinations of pharmaceutical products, attributes of the products, and attributes of the combinations;
the computer comparing the at least one entity with each of the products, with each of the combinations, and with each of the attributes; and
the computer assigning, based on the comparisons, an importance rating to each pharmaceutical product and each combination thereof named in the at least one document.

8. The method of claim 7, wherein the entities comprise authors, author affiliations, pharmaceutical products, combinations of pharmaceutical products, clinical trials, clinical trials sponsors, companies, and institutions.

9. The method of claim 7, wherein attributes comprise owners and co-owners of pharmaceutical products and combinations of pharmaceutical products, phase of clinical development of pharmaceutical products and combinations of pharmaceutical products, therapeutic area and relevant disease of pharmaceutical products or combinations of pharmaceutical products, regulatory status of pharmaceutical products or combinations of pharmaceutical products, patent status of pharmaceutical products or combinations of pharmaceutical products, clinical trials associated with pharmaceutical products or combinations of pharmaceutical products, sponsors of clinical trials, institutions and investigators involved in clinical trials, and identification numbers of clinical trials.

10. The method of claim 7, further comprising the computer increasing ratings based on at least one of determination by that one of a pharmaceutical product and a combination has a non-expired patent status and a determination that a clinical trial referenced in the document is or was sponsored by an owner of the pharmaceutical or combination.

11. The method of claim 7, further comprising the computer one of increasing and decreasing ratings based on a placement of a pharmaceutical product in the at least one document.

12. The method of claim 7, further comprising the computer using importance ratings to at least one of order products and combinations thereof by importance and to sort the products into categories comprising primary or secondary.
